(19) United States
(12) Patent Application Publication
(10) Pub. No.: US 2012/0033860 A1
(43) Pub. Date: Feb. 9, 2012

(54) MOBILE PHONE SECURITY SYSTEM AND OPERATING METHOD THEREOF

(75) Inventor: CHIEN-LIH LUNG, Tu-Cheng (TW)

(73) Assignee: HON HAI PRECISION INDUSTRY CO., LTD., Tu-Cheng (TW)

(21) Appl. No.: 13/026,307

(22) Filed: Feb. 14, 2011

(30) Foreign Application Priority Data
Aug. 4, 2010 (TW) 99125836

(51) Int. Cl. H04M 1/66; G06K 9/00

(52) U.S. Cl. 382/117; 455/411

(57) ABSTRACT

A mobile phone security system includes a trigger module, an image acquisition module, a microprocessor and a database. The trigger module is capable of triggering the image acquisition module to capture at least one pupil image of a proximal party. The database is coupled with the microprocessor and capable of storing pupil images of authorized users. The microprocessor includes a comparison module and a response module. The comparison module is capable of comparing the pupil image captured by the image acquisition module with the stored pupil image, and generating a result notification. The response module is capable of making a determination as to whether or not the captured pupil image matches the at least one pupil image stored in the database, and generating a responsive action to lock or unlock the mobile phone. The disclosure further provides a method for using the mobile phone security system.

### BACKGROUND

1. Technical Field

The present disclosure generally relates to security systems, and more particularly to a mobile phone security system and an operating method thereof.

2. Description of Related Art

Auxiliary functionality of a mobile phone may typically include phone book systems, network settings, short message services, and mobile banking. However, if the mobile phone is lost or stolen, there is nothing that can be done to prevent unauthorized access to private information on the mobile phone.

Therefore, there is room for improvement within the art.

### BRIEF DESCRIPTION OF THE DRAWINGS

The components in the drawings are not necessarily drawn to scale, the emphasis being placed upon clearly illustrating the principles of the present disclosure. Moreover, in the drawings, like reference numerals designate corresponding parts throughout several views, and all the views are schematic.

FIG. 1 is a block diagram of an embodiment of a mobile phone security system.

FIG. 2 is a flowchart of an operating method of FIG. 1.

### DETAILED DESCRIPTION

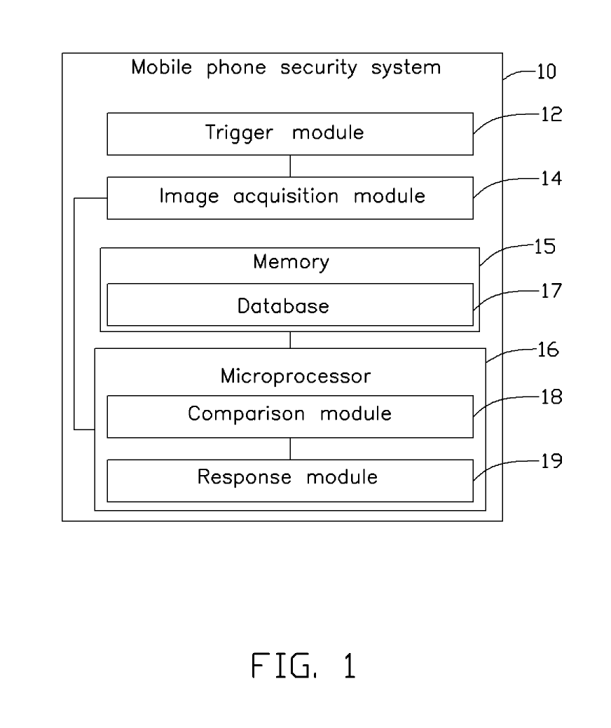

Referring to FIG. 1, a mobile phone security system 10 includes a trigger module 12, an image acquisition module 14, a memory 15 and a microprocessor 16. The memory 15 stores a database 17. The memory 15 is coupled with the microprocessor 16. The microprocessor 16 includes a comparison module 18 and a response module 19.

The trigger module 12 is capable of triggering the image acquisition module 14. In the illustrated embodiment, the trigger module 12 includes a detection device (not shown) disposed on a keypad or a keypad area of the mobile phone. When contact is made with the keypad or the keypad area, the detection device registers the contact, and the trigger module 12 triggers the image acquisition module 14.

The image acquisition module 14 is positioned on the mobile phone, and includes a camera (not shown) and an illumination device (not shown). The camera captures at least one pupil image of a proximal party triggering the trigger module 12. The illumination device supports the image acquisition module 14 under insufficient light. Brightness of the illumination device may change periodically to stimulate the pupil to shrink or dilate, such that a plurality of pupil images may be captured. The illumination device may be an infrared illumination device, so as to capture more detailed texture of the pupil of the proximal party and protect the pupil thereof from damage by the bright light emitted by the illumination device.

The memory 15 may be a NAND FLASH, dynamic random access memory (DRAM), synchronous dynamic random access memory (SDRAM), or other types of memory. The memory 15 is coupled with the microprocessor 16

The microprocessor 16 is coupled with a control unit (not shown) of the mobile phone.

The database 17 is configured to store the pupil images of at least one authorized user, the plurality of the pupil images can be acquired using the image acquisition module 14.

The comparison module 18 is used to compare the pupil images captured by the image acquisition module 14 with the stored pupil images in the database 17 by performing comparisons between the captured and stored pupil images, and generates a result notification to the response module 19.

The response module 19, based on the comparison result generated by the comparison module 18, implements a corresponding responsive action for locking or unlocking the mobile phone accordingly. In the illustrated embodiment, if the similarity between the captured pupil image and the at least one stored pupil image in the database 17 exceeds or equals a preset value, the response module 19 unlocks the mobile phone. If the similarity between the captured pupil image and each of the pupil images stored in the database 17 is less than the preset value, the response module 19 locks the mobile phone.

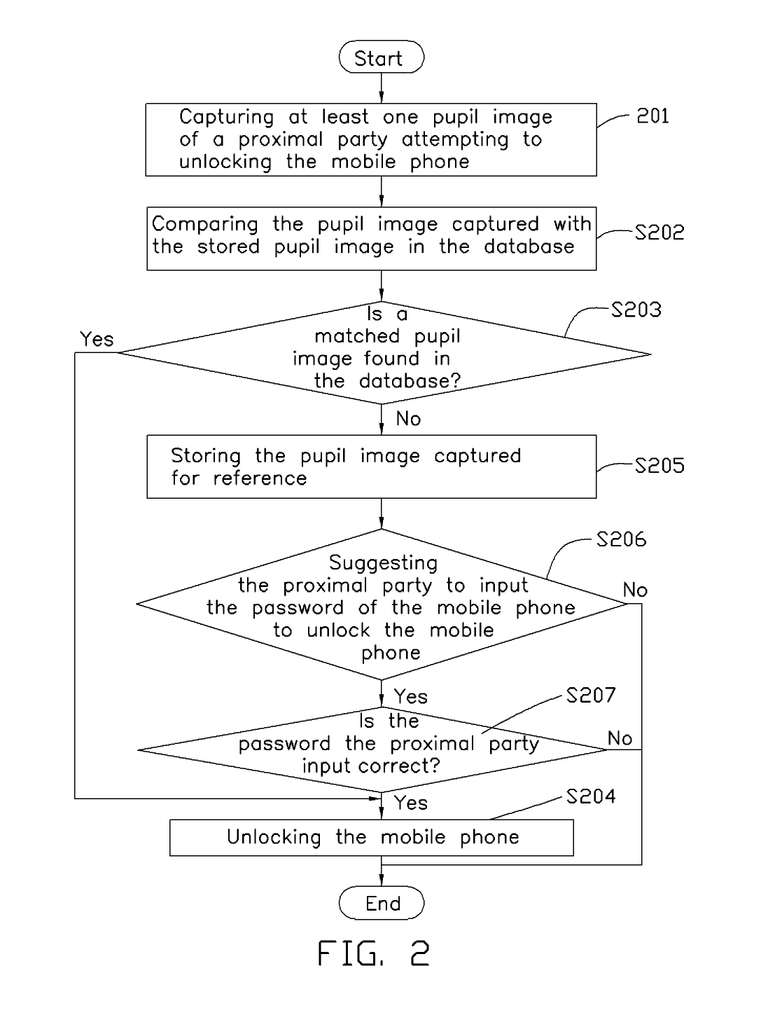

Referring to FIG. 2, a method for unlocking a mobile phone using the mobile phone security system shown in FIG. 1 is as follows.

In step S201, at least one pupil image of a proximal party attempting to unlock the mobile phone is captured. In the illustrated embodiment, the at least one pupil image is captured by an image acquisition module 14 triggered by a trigger module 12 when the proximal party makes contact with a keypad or a keypad area of the mobile phone.

In step S202, the captured pupil image of the proximal party is compared with each of the stored pupil images in the database 17. In the illustrated embodiment, the captured pupil image is compared with the stored pupil image in the database 17 by a comparison module 18 by calculating a similarity between the captured pupil image and each of the stored pupil images in the database 17.

In step S203, a determination is made as to whether or not the pupil image captured by the image acquisition module matches the at least one pupil image stored in the database 17. In the illustrated embodiment, if the similarity between the captured pupil image and each pupil image stored in the database is less than a preset value, step S205 is implemented. If the similarity between the captured pupil image and at least one stored pupil image in the database exceeds or equals the preset value, step S204 is implemented.

In step S204, the mobile phone is unlocked.

In step S205, the captured pupil image is stored for reference.

In step S206, a request or suggestion is made to the proximal party to input a password of the mobile phone to unlock the mobile phone. If the proximal party chooses “yes”, step S207 is implemented, otherwise, the method is completed and terminates.

In step S207, the microprocessor 16 determines whether the password the proximal party has inputted is correct or not, and if the password is correct, step 204 is implemented, otherwise, the method is completed and terminates.

The mobile phone security system 10 generates an appropriate decision to lock or unlock the mobile phone by capturing one or more pupil image of a proximal party for comparison with the stored pupil images of one or more authorized users, thereby securing private information stored on the mobile phone. Furthermore, the user does not need to input a password to unlock the mobile phone every time, thereby enhancing convenience.

Finally, while various embodiments have been described and illustrated, the disclosure is not to be construed as being limited thereto. Various modifications can be made to the embodiments by those skilled in the art without departing from the true spirit and scope of the disclosure as defined by the appended claims.

What is claimed is:

1. A mobile phone security system, comprising:
a trigger module;
an image acquisition module for capturing at least one pupil image of a proximal party triggering the trigger module;
a microprocessor, the microprocessor comprising a comparison module and a response module; and
a database, the database is coupled with the microprocessor, wherein the trigger module is capable of triggering the image acquisition module, the database is capable of storing at least one pupil image of at least one authorized user, the comparison module is capable of comparing the pupil image of the proximal party captured by the image acquisition module with the stored pupil image in the database, and generating a result notification to the response module, the response module is capable of making a determination as to whether or not the pupil image captured by the image acquisition module matches the at least one pupil image stored in the database according to an output signal which is the comparison result, and the response module is capable of generating a corresponding responsive action to lock or unlock the mobile phone responding to the determination.

2. The mobile phone security system of claim 1, wherein the trigger module comprises a detection device positioned on a key pad of the mobile phone.

3. The mobile phone security system of claim 1, wherein the trigger module comprises a detection device disposed on a keypad area of the mobile phone.

4. The mobile phone security system of claim 1, wherein the image acquisition module comprises a camera and an illumination device.

5. The mobile phone security system of claim 4, wherein the illumination device is an infrared illumination device.

6. The mobile phone security system of claim 4, wherein a brightness of the illumination device changes periodically.

7. The mobile phone security system of claim 1, wherein the comparison module is adapted to compare the pupil image captured by the image acquisition module with the stored pupil image in the database by calculating a similarity between the captured pupil image and the stored pupil image in the database, and the output signal is the similarity calculated by the comparison module.

8. A method for vehicle security, comprising:
capturing at least one pupil image of a proximal party attempting to unlock the mobile phone;
comparing the captured pupil image of the proximal party with at least one stored pupil image in a database;
determining whether or not a matched pupil image is found in the database; and
unlocking the mobile phone if the matched pupil image is found in the database.

9. The method of claim 8, wherein the step of determining if a matched pupil image is found in the database comprises: determining that the matched pupil image is found if the similarity between the captured pupil image and the at least one stored pupil image in the database exceeds or equals a preset value; and determining that no matched pupil image is found in the database if the similarity between the captured pupil image and each pupil image stored in the database is less than the preset value.

10. The method of claim 8, further comprising: making a suggestion to the proximal party to input a password of the mobile phone if no matched pupil image is found in the database, and unlocking the mobile phone if the password that the proximal party has inputted is correct.
